(19) United States
(12) Patent Application Publication
(10) Pub. No.: US 2001/0037224 A1
(43) Pub. Date: Nov. 1, 2001

(54) Method and system for submitting and tracking insurance claims via the internet

(76) Inventors: James A. Eldridge, Olathe, KS (US); Robbie L. Tanner, Blythewood, SC (US); William J. Burtle, Arlington, VA (US)

Correspondence Address: SCOTT B. STROHM, SHOOK, HARDY & BACON L.L.P., One Kansas City Place, 1200 Main Street, Kansas City, MO, 64105-2118, US

(21) Appl. No.: 09/773,333

(22) Filed: Jan. 31, 2001

Related U.S. Application Data
(60) Provisional application No. 60/179,232, filed on Jan. 31, 2000.

(51) Int. Cl. G06F 17/60

(52) U.S. Cl. 705/4

(57) ABSTRACT

A method of submitting insurance reports or claims over the Internet is provided. In one embodiment, a transmitter client submits a claim file or report over the Internet to a transmitter/reporter database on a remote server. The transmitter/reporter database performs certain checks and edits of the received claim file or report, and then transmits the claim file or report to the appropriate state or jurisdiction. Upon receipt of the claim file or report, the jurisdiction will transmit back to the transmitter/reporter database an acknowledgement for each claim record within the report. The transmitter/reporter database performs certain checks on the acknowledgement file and then transmits the acknowledgements back to the inbox of the transmitter client.

### CROSS-REFERENCE TO RELATED APPLICATION

This application claims the benefit of U.S. Provisional Application No. 60/179,232, filed Jan. 31, 2000.

### TECHNICAL FIELD

The present invention relates to a computer system and, more particularly, to a computer system and method that allow reports, such as insurance claims, to be submitted and tracked via a computer network environment

### BACKGROUND OF THE INVENTION

In accordance with state law, employers must report workers' compensation reports and coverage data to a state agency. These state agencies may be referred to as jurisdictions. Employers may accomplish this reporting through an insurance company that provides workers' compensation insurance, a third party administrator that is paid to process the employer's claims, or the employer may be self-insured and perform the reporting directly. Any entity performing the reporting may be referred to as a carrier or a client. Jurisdictions require reporting in varying degrees, but typically require First and Subsequent Reports of Injury (“FROI” and “SROI,” respectively), Proof of Coverage (“POC”), and Medical Reports (“Med”).

Historically, these claims and reports have been inefficiently transmitted via paper correspondence or with out-dated electronic filing solutions. Recently, a trend has emerged in which jurisdictions have begun to mandate that clients report workers' compensation data in an electronic format.

The traditional reporting methods have proven difficult to adopt, poorly supported and not cost effective or timely, for both clients and jurisdictions. The jurisdictions' reporting requirements have proven to be onerous and expensive to clients, primarily because each jurisdiction has different reporting requirements (which often change), different operating systems, and different formats with which the submitted data must comply to be accepted. Additionally, clients may be subject to penalties if the data that is being submitted does not comply with rules that have been established in each jurisdiction. Personnel from both the clients and jurisdictions spend days corresponding and resubmitting data that is not in reporting compliance.

An example of a traditional reporting method can be understood with reference to FIG. 1. FIG. 1 illustrates the operation of a system that is known as a Value Added Network, or VAN. In the VAN system, a client, such as CLIENT1, will access the VAN via a telephone line. The client will then transmit information, such as a CLAIM1, to the VAN over the telephone line. The VAN will then transmit the information received to the appropriate jurisdiction, such as STATE1, over a telephone line. Upon receipt of the claim, the jurisdiction will later transmit back to the VAN an acknowledgement of the claim, which is labeled ACK1 in FIG. 1. This acknowledgement is then transmitted back to the client. If the client has reports or claims that need to be submitted to additional jurisdictions, the process is repeated, as illustrated with respect to CLAIM2, STATE2 and ACK2.

The VAN system presents certain drawbacks and deficiencies in use. Because the files are being transmitted over a telephone line, the VAN system is somewhat limited in the speed with which transactions can be completed. Another drawback presented by the use of the telephone line is the possibility of losing the connection. If the connection is lost using the VAN system, a partial file transfer may take place. This partial file transfer introduces delay into the reporting of claims, as the complete file must be re-transferred by the client after being notified of the partial file transfer.

The VAN system does not perform any checks on the transmission of the claims or reports from the client. Therefore, if there are errors in the report transmission being transmitted, the jurisdiction will inform the client via the acknowledgement. The acknowledgement will typically only inform the client of an error, and will not direct the client to the specific error in the report transmission. This requires the client to investigate the report transmission originally sent, identify the error in the report transmission, and re-send the report transmission to the VAN and eventually the jurisdiction. For example, the client is typically identified by a Federal Employer Identification Number (FEIN) and a postal code. If these numbers are incorrectly entered, the client will not be informed of the error until the acknowledgement is transmitted from the jurisdiction.

The VAN system also does not perform any formatting of the claim or report file received from the client. As an example, some jurisdictions require one type of file format, while another jurisdiction may require a completely different type of file format. Because the VAN system does not perform any formatting or translation service, the client must know what format a particular jurisdiction requires. The burden is then on the client to properly format the reports prior to submitting them to the VAN. It can be seen that such a system places a large administrative burden on the client.

Further, the VAN system does not allow the client, or the jurisdiction, to track the report or acknowledgement submissions. It would be beneficial to track the reports or claims submitted, and the acknowledgements sent, so that both the client and the jurisdiction can be informed of the status of the transactions.

A need therefore exists for a method and system that overcomes the above-identified drawbacks and deficiencies.

### SUMMARY OF THE INVENTION

Generally described, a method of submitting insurance reports or claims over the Internet is provided. In one embodiment, a transmitter client submits a claim file or report over the Internet to a transmitter/reporter database on a remote server. The transmitter/reporter database performs certain checks and edits of the received claim file or report, and then transmits the claim file or report to the appropriate state or jurisdiction. Upon receipt of the claim file or report, the jurisdiction will transmit back to the transmitter/reporter database an acknowledgement for each claim record within the report. The transmitter/reporter database performs certain checks on the acknowledgement file and then transmits the acknowledgements back to the inbox of the transmitter client.

In another embodiment, an online reporter client accesses the transmitter/reporter database on the server. The transmitter/reporter database displays to the reporter client a menu of available options, one of which is the creation of a claim report in the correct format. The reporter client is prompted to input the required information so that a claim report can be generated. Once generated, the claim report is submitted to the transmitter/reporter database where it is held until requested by the appropriate jurisdiction. When requested, the claim report is transmitted to the jurisdiction by the transmitter/reporter database. An acknowledgement is then transmitted by the jurisdiction back to the transmitter/reporter database over the Internet connection. The acknowledgement is held by the transmitter/reporter database for later viewing by the online reporter client.

Additional advantages and novel features of the invention will be set forth in part in a description which follows, and in part will become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawing figures, wherein:

FIG. 1 is a schematic diagram illustrating the prior art methods used to transmit claim or other insurance information;

FIG. 2 is a schematic diagram illustrating the operation and components of the present invention;

FIG. 3A is a flow chart illustrating one embodiment of the present invention;

FIG. 3B is a continuation of the flow chart of FIG. 3A;

FIG. 4 is a flow chart illustrating another embodiment of the present invention; and

FIG. 5 is a block diagram of a suitable computing system environment for use in implementing the present invention.

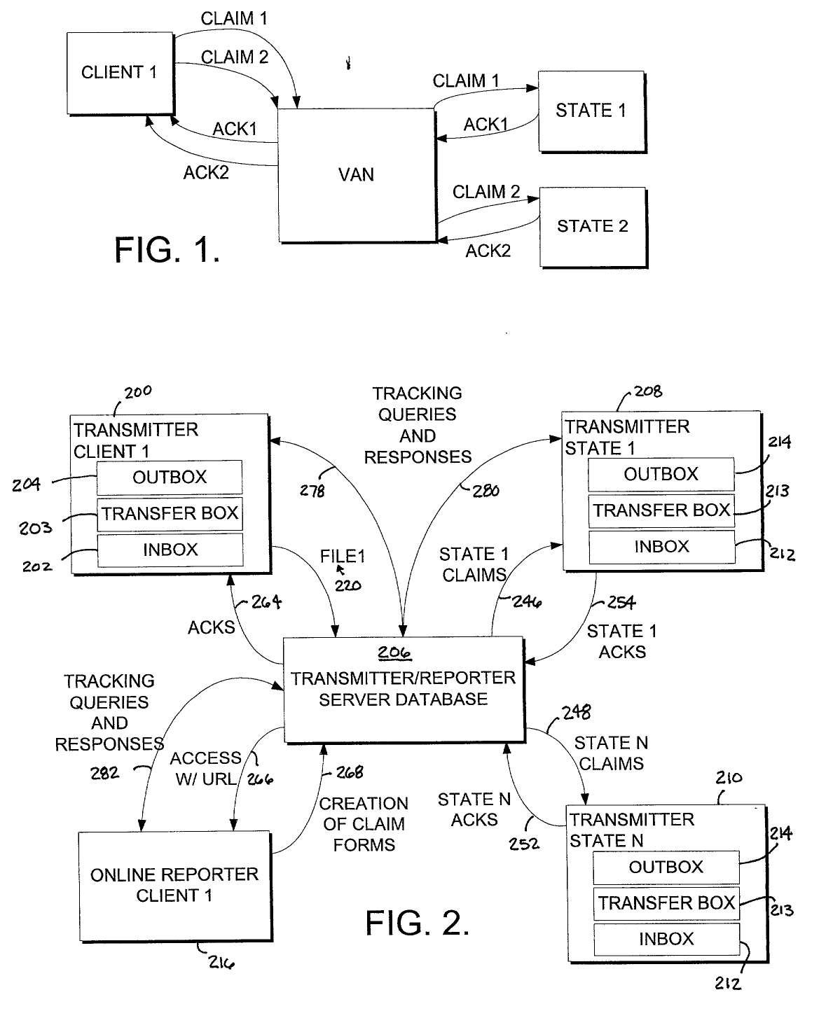

### DETAILED DESCRIPTION OF THE INVENTION

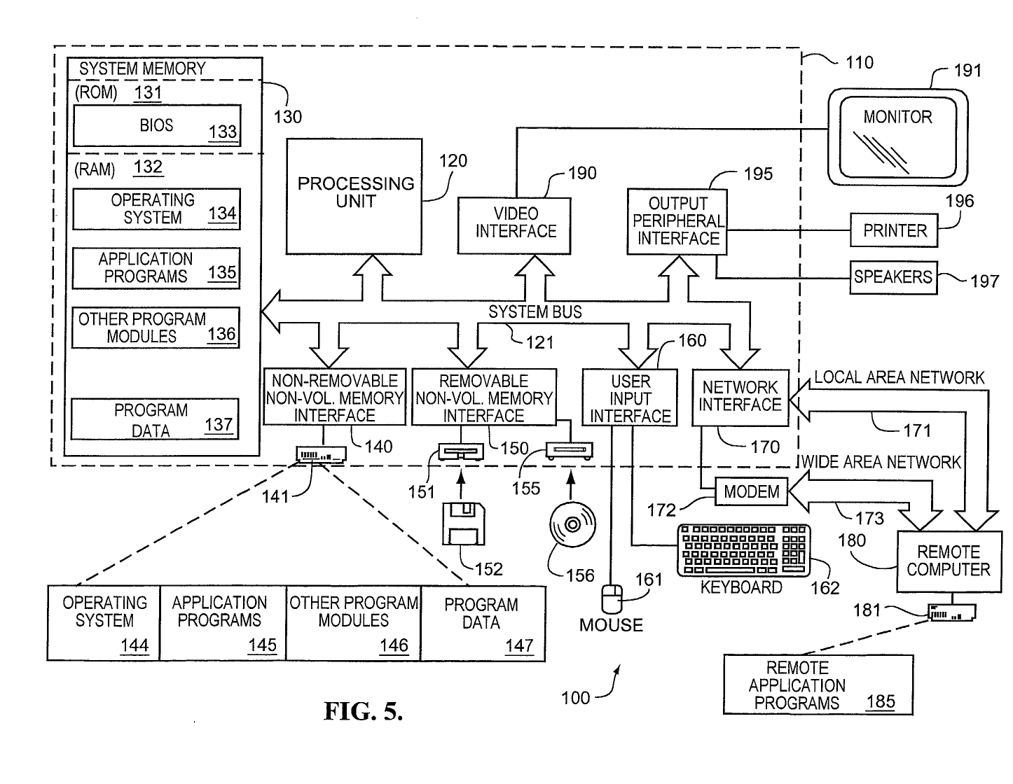

The present invention provides a system and method for submitting, acknowledging and tracking insurance reports or claims via a networked environment, such as the Internet. FIG. 5 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 5, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 5 illustrates operating system 134, application programs 135, other program modules 136, and program data 137.

The computer 110 may also include other removable/non-removable, volatile/nonvolatile computer storage media. By way of example only, FIG. 5 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 5, provide storage of computer readable instructions, data structures, program modules and other data for the computer 110. In FIG. 5, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 can operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 5. The logical connections depicted in FIG. 5 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 5 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

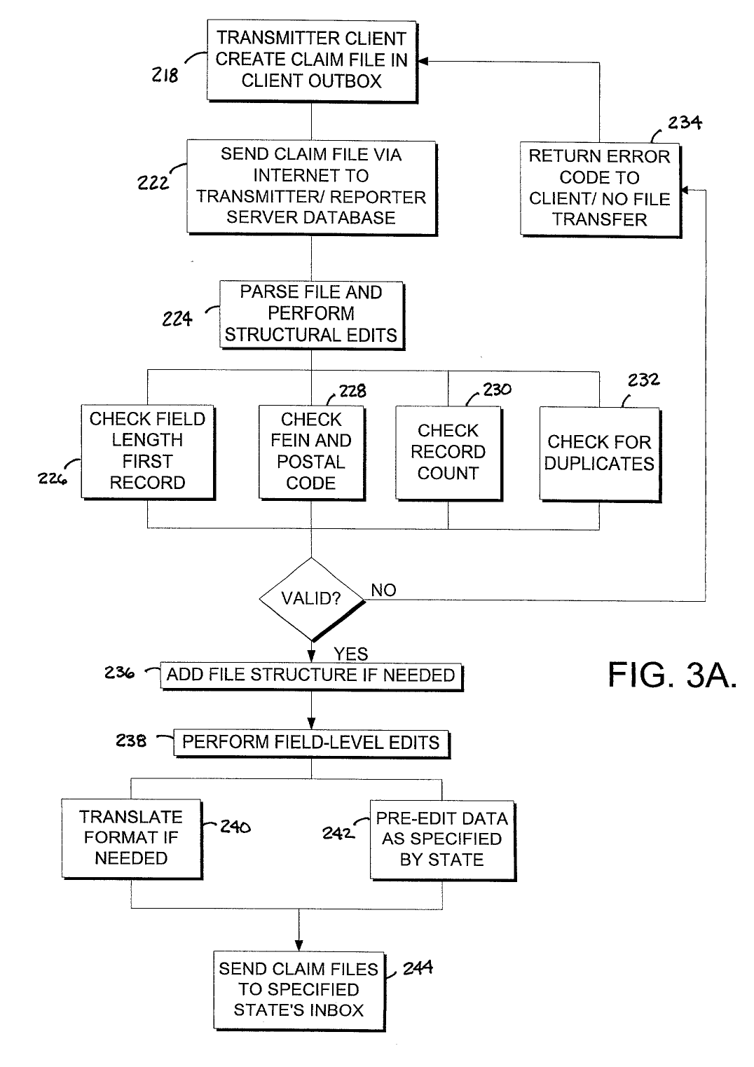

Turning now to FIG. 2, the basic architecture used in one embodiment of the present invention is illustrated. In FIG. 2, a client computer having a transmitter program thereon is labeled as numeral 200. Client 200 is labeled as TRANSMITTER CLIENT 1, with the understanding that the invention applies to any number of client computers. Client 200 is provided with an inbox 202, a transfer box 203 and an outbox 204. The transmitter program on client 200 allows client 200 to provide information to outbox 204 and to obtain information from inbox 202. The information received may be viewed on the monitor 191, or may be printed in a hard-copy form. After information is successfully transmitted, outbox 204 transfers the information to transfer box 203 for archiving purposes.

Client 200 is connected to a remote computer (such as computer 180 discussed above) that houses a transmitter/reporter server database 206. The connection between client 200 and transmitter 206 is accomplished via a networked environment, preferably the Internet. The transmitter 206 preferably exists on a secure server to ensure that any privacy concerns are met regarding the information being exchanged. As more fully explained below, client 200 will transfer information, labeled FILE 1, from the outbox 204 to transmitter 206 at a desired time. FILE 1 is typically a file containing various worker's compensation reports, such as FROI, SROI, POC and MED reports. The file will also typically contain a header and a trailer with basic information identifying the client, as well as information about FILE 1. As more fully discussed below, it is not necessary that the file contain the header and trailer, as those items can be added by transmitter 206. It is known to wrap EDI records in header-trailer pairs. The header indicates who the transmission is from, who the transmission is to, and the type of records contained within the file. The header may contain additional information as well. The trailer typically marks the end of the file and will indicate how many records were contained within the file. After information is successfully transmitted, outbox 204 transfers the information to transfer box 203 for archiving purposes.

Transmitter 206 is also connected to a remote computer of a jurisdiction having a transmitter program thereon. For example, transmitter 206 is connected to computers in jurisdictions labeled STATE 1 and STATE N, labeled as 208 and 210 respectively in FIG. 2. Similar to client 200, the invention applies to any number of jurisdiction or state computers. STATE 1 (208) and STATE N (210) are each provided with an inbox 212, a transfer box 213 and an outbox 214. The transmitter program on states 208 and 210 allows the respective state or jurisdiction to provide information to outbox 214 and to obtain information from inbox 212. The information received may be viewed on the monitor 191, or may be printed in a hard-copy form.

In FIG. 2, a client computer having an online reporter program thereon is labeled as numeral 216. Client 216 is labeled as ONLINE REPORTER CLIENT 1, with the understanding that the invention applies to any number of online reporter client computers. Client 216 will typically be used by entities with a fewer number of reports or claims than those using transmitter client programs. Client 216 is provided access to transmitter/reporter database 206 and has a unique identifier that allows database 206 to identify client 216. Client 216 is connected to transmitter/reporter database 206 over a networked connection, preferably the internet. Once connected with database 206, client 216 will create the necessary report forms based upon prompts from the database 216, as is more fully described below.

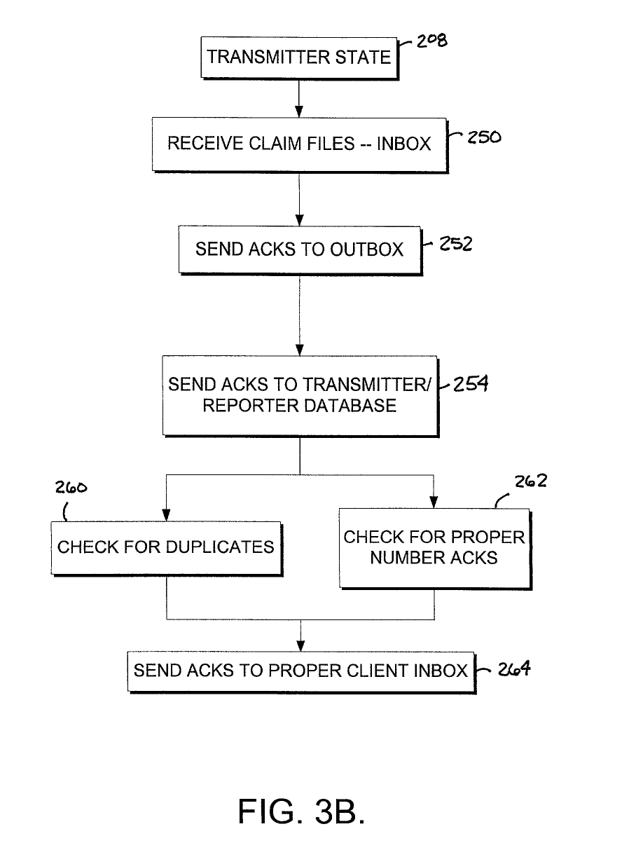

Turning now to FIGS. 3A and 3B, the operation of transmitter client 200, transmitter database 206 and jurisdictions 208 and 210 can be seen. Beginning with step 218, transmitter client 200 creates a claim file. Again, this claim file may contain various reports, such as FROI, SROI, POC and MED reports. It is to be understood that the invention is in no way limited to the type of reports created by client 200. When the claim file is complete, it is transferred to the outbox 204. The claim file, labeled claim 1 and numeral 220 in FIG. 2, is then sent to transmitter database 206 in step 222 of FIG. 3A. The claim file is sent to database 206 over the network connection, which is preferably the Internet. The file delivered may also be called a “transmission.” A transmission can have one or more header-trailer pairs. Since a transmission is delivered to just one entity, all of the headers in the file should indicate the same receiving party. There would potentially be more than one header-trailer block in the file because of some combination of different senders, different record types and different send-dates. Each header will indicate the date and time the transmission was sent, regardless of the date and time the transmission was actually delivered. The transfer of claim file 220 may be initiated by an operator of client 200. In this mode of operation, the operator would initiate the transfer through a positive instruction to immediately begin the transfer. On the other hand, the transfer of claim file 220 may be programmed to occur at a specified time with a specified frequency. For example, client 200 could transfer claim file 220 to transmitter database 206 each day at the close of business. After information is successfully transmitted, outbox 204 transfers the information to transfer box 203 for archiving purposes.

Once received by transmitter database 206, the database 206 parses the file and reviews the file for a series of structural edits in step 224. One structural edit that is performed in step 226 is to check the field length of the first record. A valid claim or report that is structured according to a standard EDI format has a known length. By checking the length of the first record, database 206 determines whether the claim file 220 contains at least one claim having the proper standard length. Database 206 could determine whether records other than the first record are of the proper length as well. However, it has been determined that if the first record is of the proper length, there is a high likelihood that the remainder of the records will also be of the proper length. Therefore, in the preferred embodiment, only the length of the first record is checked.

Another check performed by database 206 on claim file 220 is a check of the client identity information in step 228. In the preferred embodiment, this information is the Federal Employer Identification Number, or FEIN, and the postal code for the client. The client identifier information included in claim file 220 is compared to the known client identifier information for client 200 to ensure that the information within claim file 220 is correct.

Database 206 also checks the number of records within claim file 220 in step 230. Claim file 220 will typically have both a header and a trailer. Within the trailer is a field that indicates the number of records being sent within claim file 220. In other words, the trailer will specify the number of claims within claim file 220. Database 206 checks the specified number in the trailer against the actual record count to ensure that the two numbers are equal. If the two numbers are not equal, the file may be missing some of the records thought to present within claim file 220. One source of this problem may be that the complete file 220 was not transferred to transmitter database 206 in step 222. Another source of this problem may be that the claim file 220 was not constructed properly by client 200 before transferring it to outbox 204.

Yet another check performed by database 206 in step 232 is to check for duplicate file transfers. At the option of the client, database 206 will check file 220 to ensure that such a file has not already been transferred to database 206.

If any of the checks performed in steps 226-232 yield an invalid claim file 220, an error code is returned to client 200 in step 234. In addition, transmitter database 206 will not initiate any further transfer of the claim file 220. If the length of the first record does not match the length of a standard record, as determined in step 226, the claims or records within file 220 are not properly entered. As such, the claims within file 220 could not be processed by the applicable jurisdiction. Therefore, it is more efficient to immediately inform client 200 of the error so that remedial steps may be taken. Similarly, if the client identifier information does not match the known client identifier information, as determined in step 228, the claims within file 220 could not be processed by the applicable jurisdiction. Again in this instance, it is more efficient to return an error code to client 200 informing it of the error in entering the client identifier information so that the error can be quickly corrected. Further, if the record count does not match the specified number of records in the trailer of file 220, as determined in step 230, the file may be incomplete. By informing the client 200 of the incomplete file with an error code, the client 200 can immediately check file 220 and re-send the complete file to transmitter database 206. Finally, if the client 200 has requested a check for duplicates, any duplicate files will not be accepted by transmitter database 206. It should be understood that additional checks could be performed by transmitter database 206, and that the invention is not limited to the above-described checks or edits.

If claim file 220 passes each of the checks identified above with respect to steps 226 232, transmitter database 206 will next determine whether any additional file structure is needed for claim file 220 in step 236. For example, client 200 may be sending a claim file 220 without the required header and trailer. Transmitter database 206 is programmed to recognize those clients 200 that need additional structure added to claim file 220. When such a client 200 sends a claim file 220 to transmitter database 206, the database will automatically generate the missing structure and add it to claim file 220. For example, a header and trailer can be added to claim file 220 by transmitter database 206.

After adding any necessary file structure, transmitter database 206 performs a series of field-level edits in step 238. These field-level edits include translating the format of claim file 220, if needed, in step 240. For example, if client 200 submits claim file 220 in a format different from that required by the target jurisdiction, transmitter database 206 will convert or translate claim file 220 into the required format. As a more specific example, client 200 may submit to transmitter database 206 a claim file 220 in a standard format known to those of skill in the art as WCPOLS. If the target jurisdiction does not accept this format, it may require a different format, such as that known as the International Association of Industrial Accident Boards and Commissions or IAIABC. In such a situation, transmitter database 206 has a conversion table and program that translates the claim file 220 from the WCPOLS format into the required IAIABC format. This allows client 200 to create claim file 220 using one known format, while not knowing that a jurisdiction requires a different known format. Therefore, client 200 is not required to translate claim file 220 itself into the particular format required by the jurisdiction.

Another field-level edit that can be performed by transmitter database 206 in step 242 is to pre-edit claim file 220. This pre-editing may be required by a jurisdiction and may be targeted at different areas. Claim file 220 may be analyzed by transmitter database 206 to determine whether all of the fields required by a jurisdiction are present. The records within claim file 220 may also be checked to ensure that each record has valid fields therewithin. As an example, each claim record may contain a two digit code indicating the type of injury suffered. This field may be analyzed to ensure that the two digit code within the record is one of the known and recognized two digit codes. Another type of pre-editing that can be performed by transmitter database 206 is to edit-out from claim file 220 all information that is not needed by the target jurisdiction. This allows client 200 to submit to transmitter database a large claim file 220, which may already be in existence for another purpose. This large claim file 220 will then be edited by transmitter database 220 so that only the information required by the jurisdiction remains. It should be understood that additional edits could be performed, and that the invention is not limited to the above-described edits.

After the above pre-editing has been performed, the claim file 220 is ready to be sent to the applicable jurisdictions. This step is shown as 244 in FIG. 3A and will be initiated by the jurisdiction requesting any claim files or reports existing on transmitter database 206 that are to be sent to the respective jurisdiction. As shown in FIG. 2, if claim file 220 contained reports or claims for STATE 1 (208), the file would be transmitted to outbox 212 of STATE 1, as indicated by the arrow labeled 246. Similarly, if claim file 220 contained reports or claims for STATE N (210), the file would be transmitted to outbox 212 of STATE N, as indicated by the arrow labeled 248. As shown in FIG. 3B, the transmitter state 208 will receive the claim file 220 in its inbox 212, as indicated by step 250. Step 250 of FIG. 3B is similar to step 244 of FIG. 3A, in that in step 244 the claim file 220 is being sent and in step 250 the claim file 220 is being received.

For each individual claim received by the jurisdiction, an acknowledgement of the claim must be generated and returned to the client. These acknowledgements are created by the transmitter at the jurisdiction, such as transmitter STATE 1, labeled as 208 in FIG. 2. After the acknowledgements are created by the transmitter STATE 1 (208), they are sent to the outbox 214, as shown at step 252 in FIG. 3B. When the jurisdiction transmitter 208 is connected to transmitter database 206, the acknowledgements within the outbox 214 are sent to transmitter database 206, as shown at step 254. As shown in steps 252 and 254, the acknowledgements are represented by the abbreviation “ACKS.” The transmission of the acknowledgements from the jurisdictions 208 and 210 in FIG. 2 are labeled as 256 and 258 respectively. After the acknowledgement information is successfully transmitted, outbox 214 transfers the acknowledgement information to transfer box 213 for archiving purposes.

Once at the transmitter database 206, the acknowledgements are analyzed by transmitter 206 to ensure that the acknowledgements are not duplicates that have already been received, as shown at step 260. Step 260 is similar in operation to step 232 with regard to claim file 220. Transmitter database 206 also checks the acknowledgements received to ensure that the number of acknowledgements received matches the number of claim records sent to the jurisdiction. After these checks have been made, transmitter database 206 sends the acknowledgements to the inbox 202 of client 200, as shown in step 264 in FIG. 3B. This completes the cycle. The client 200 generates and sends a claim file 220 to the transmitter database 206 over the Internet. The transmitter database performs certain checks and edits of the claim file 220 and then sends the claim file to the targeted jurisdiction at the requested time. The jurisdiction transmitter 208 then generates and sends acknowledgements for each claim record received to the transmitter database 206. The transmitter database 206 again performs certain checks and then sends the acknowledgements to the sending jurisdiction.

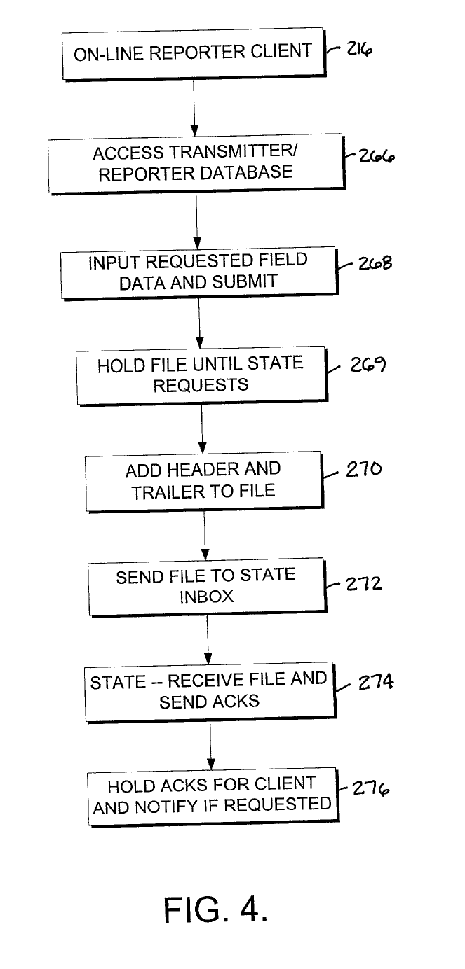

The above-described embodiment is typically used by mid-size and larger companies. These companies are better equipped to generate the claim file 220 and have a sufficient amount of claims or reports to justify the creation of claim file 220. However, smaller companies may not have the number of claims or reports, or the resources, to justify the regular generation of claim file 220. These smaller companies may use a different embodiment of the present invention directed to online reporter 216. The operation of online reporter 216 is shown in the flow chart of FIG. 4.

Online reporter 216 does not initially create a claim file 220 as would client 200. Instead, online reporter 216 requires an operator or user of the computer to access the transmitter/reporter database 206, as shown at step 266. This access is accomplished via the Internet using a Uniform Resource Locator, or URL. Once a connection is established between the online reporter 216 and the transmitter/reporter database 206, the operator of the computer that is hosting reporter 216 may create a claim report, such as an FROI, SROI, POC or MED report. Each of these reports requires information specified by the jurisdiction. The transmitter/reporter database 206 will instruct the operator to input the required data according to the fields required to build the proper file report format. The forms and format are translated directly from a known standard, such as the IAIABC EDI Implementation Guide. In order to help the operator eliminate data-entry errors, the operator is provided with select lists and radio buttons, instead of inputting alphanumeric codes. The operator will then input the requested field data, as shown at step 268 and will submit the claim or report to the transmitter/reporter database 206 after all of the needed data is input. Steps 266 and 268 are also labeled in FIG. 2.

As shown at step 269, the transmitter/reporter database will hold the claim file built by the online reporter client 216 until the jurisdiction requests the file from database 206. If the operator of online reporter 216 again accesses the transmitter/reporter database to create additional claims or reports prior to the jurisdiction requesting the file from database 206, any additional claims or reports are merely added to the existing file. When the jurisdiction requests the claims or reports, transmitter/reporter database 206 will add the needed header and trailer to the file, as shown at step 270. After the header and trailer have been added to the file, the claims file or report is sent to the inbox 212 of the requesting jurisdiction, such as STATE 1 labeled 208 in FIG. 2. This step is shown as 272 in FIG. 4. The requesting jurisdiction will receive the claims and reports of the online reporter that were created and will send the appropriate acknowledgements, as shown in step 274. The acknowledgements sent by the jurisdiction are sent to the transmitter/reporter database 206 and are held there, as shown in step 276. The acknowledgements can be viewed by the operator of the online reporter when the transmitter/reporter database 206 is again accessed by online reporter 216. Optionally, transmitter/reporter database 206 can send a notification to the operator of online reporter 216, such as by an electronic mail message. Such a message would indicate to the operator that acknowledgements had been received by the transmitter/reporter database and are available for viewing. Therefore, rather than sending the acknowledgements directly to the client 200 as in the transmitter embodiment, the transmitter/reporter database will hold the acknowledgements in the online reporter embodiment.

When online reporter 216 first connects with transmitter/reporter database 206 a menu of options is displayed on a graphical user interface, such as a monitor. The operator of online reporter 216 may then choose to create an FROI, SROI, POC or MED report. The user also is presented with the option to view any acknowledgements existing for the online reporter client 216 and held by database 206. Similarly, the operator can opt to view tracking information for previously submitted claim or report information.

A tracking system is also provided by the present invention. Returning to FIG. 2, transmitter client 200 may submit to transmitter/reporter database 206 a tracking query and receive a response from the transmitter/reporter database 206 regarding the status of any claim file 220 that has been sent, as represented by the double-headed arrow 278. Transmitter/reporter database 206 can inform client 200 if the claim file 220 has been received by database 206; if the claim file 220 has been sent to the jurisdiction; if the jurisdiction has submitted acknowledgements for the claim file 220 and if the acknowledgements have been received by the client 200. These same queries and responses may be exchanged between the jurisdiction and the transmitter/reporter database 206, as shown by arrow 280. Similarly, the queries and responses may be exchanged between the online reporter client 216 and the transmitter/reporter database 206, as shown by arrow 282. Tracking information is available at the claim file level in the transmitter client embodiment, but is available at the record level in the online reporter embodiment.

All programming of the client 200, the jurisdictions 208, 210 and the online reporter 216 is preferably done using the DELPHI language. It should be understood that other languages could be used, such as JavaScript.

It can therefore be seen that the present invention can be used to overcome the drawbacks and disadvantages existing in the prior art identified in the background section. A variety of insurance claims or reports may be efficiently submitted to the proper jurisdiction over the Internet. Moreover, the claims or reports submitted are parsed and validated prior to submitting them to the jurisdiction, which results in fewer delays and administrative aggravation.

Alternative embodiments of the present invention will become apparent to those skilled in the art to which it pertains upon review of the specification, including the drawing figures. Accordingly, the appended claims rather than the foregoing description define the scope of the present invention.

We claim:

1. A method in a computer system for submitting insurance reports, the method comprising:
creating, with a client computer, a claim file containing at least one insurance report, said report being formatted in one of a set of known standard formats;
transmitting said claim file to a jurisdiction over a computer network connection; and
receiving an acknowledgement from said jurisdiction over said computer network connection.

2. The method of claim 1, wherein said transmitting step comprises:
sending said claim file to a transmitter database; and
sending said claim file from said transmitter database to said jurisdiction when said jurisdiction is connected with said transmitter database.

3. The method of claim 2, wherein said receiving step comprises:
receiving, by said transmitter database, said acknowledgement from said jurisdiction for each report; and
sending, to said client computer, said acknowledgement form from said transmitter database.

4. The method of claim 3, wherein said insurance report within said claim file is an insurance claim.

5. The method of claim 3, further comprising performing, by said transmitter database, structural edits on said claim file prior to sending said claim file to said jurisdiction.

6. The method of claim 5, further comprising performing, by said transmitter database, field-level edits on said claim file prior to sending said claim file to said jurisdiction.

7. The method of claim 3, further comprising performing, by said transmitter database, edits upon said acknowledgement prior to sending said acknowledgement from said transmitter database.

8. The method of claim 3, further comprising tracking a status of said report through said transmitting and receiving steps.

9. The method of claim 1, wherein said creating step comprises:
accessing a transmitter/reporter database;
receiving, from said transmitter/reporter database, prompts for information; and
inputting, with said client computer, information as prompted by said transmitter/reporter database,
wherein said client computer interacts with said transmitter/reporter database to create a claim file that is formatted in one of a set of known standard formats.

10. The method of claim 1, wherein the network is the Internet.

11. A computer-readable medium having computer-executable instructions for performing the steps recited in claim 1.

12. A computer system having a memory, an operating system and a central processor, said processor being operable to execute the instructions stored on the computer-readable medium of claim 11.

13. A computer-readable medium having computer-executable components for managing the transfer of insurance reports over a network, comprising:
a receiving component which receives claim files containing at least one insurance report over a computer network connection from at least one client;
a transmitting component which transmits said claim file to a predetermined jurisdiction over a computer network connection; and
a receiving component which receives an acknowledgement from said jurisdiction over said computer network.

14. The computer-readable medium of claim 13, further comprising a transmitting component which transmits said acknowledgement received from said jurisdiction to said client.

15. The computer-readable medium of claim 13, further comprising a notification component which notifies said client upon receiving said acknowledgement from said jurisdiction.

16. The computer-readable medium of claim 15, further comprising an editing component which performs structural edits upon said claim files prior to activation of said transmitting component.

17. The computer-readable medium of claim 15, further comprising an editing component which performs field-level edits upon said claim files prior to activation of said transmitting component.
